(19) United States
(12) Patent Application Publication
(10) Pub. No.: US 2007/0273849 A1
(43) Pub. Date: Nov. 29, 2007

(54) PROJECTOR

(75) Inventor: Takashi Takeda, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/683,083

(22) Filed: Mar. 7, 2007

(30) Foreign Application Priority Data
Apr. 4, 2006 (JP) 2006-102955

(51) Int. Cl. G03B 21/00

(52) U.S. Cl. 353/122

(57) ABSTRACT

A projector includes: an image forming unit that forms an image using light emitted from a solid-state light source; a diffusion unit which is provided at focal positions of light components of the image formed by the image forming unit and diffuses the light; and a projection optical system that projects the light emitted from the diffusion unit.

### BACKGROUND

1. Technical Field

The present invention relates to a projector, and more particularly, to a projector using a laser light source.

2. Related Art

In general, when a laser beam, which is coherent light, is radiated to a diffusion surface, an interference pattern, called a speckle pattern having bright spots and dark spots distributed randomly, appears. The speckle pattern is generated by the interference between light components diffused from the diffusion surface at different points. When the speckle pattern is generated on a displayed image, flicker with dazzling light occurs on the screen, so that a viewer cannot see a clear image on the screen. For example, in a front projector, it is desirable to reduce speckles using the structure of an optical path from a light source to a projection optical system. For example, JP-A-11-64789 discloses a technique for reducing speckles using a fly eye lens provided on an optical path from a light source to a projection optical system.

In the technique disclosed in JP-A-11-64789, the fly eye lens rotates to superimpose a plurality of speckle patterns. In this case, a component for rotating the fly eye lens is needed and the component needs to have sufficient durability for the rotation, which results in an increase in the manufacturing costs of the device. In addition, it is necessary to rotate the fly eye lens for deviding light into a plurality of light component at a high speed in order to sufficiently change the speckle pattern. A relatively large and complicated structure is needed to rotate the fly eye lens at high speed, which may cause an, increase in noise. As described above, the related art has a problem in that it is difficult to reduce speckles with a simple structure.

### SUMMARY

An advantage of some aspects of the invention is that it provides a projector capable of reducing speckles with a simple structure.

According to an aspect of the invention, a projector includes: an image forming unit that forms an image using light emitted from a solid-state light source; a diffusion unit which is provided at focal positions of light components of the image formed by the image forming unit and diffuses the light; and a projection optical system that projects the light emitted from the diffusion unit.

According to the above-mentioned structure, it is possible to form an image on the screen using light diffused by the diffusion unit by forming an intermediate image on the diffusion unit. In addition, it is possible to reduce the interference between light components by increasing the diffusion angle of light by the diffusion unit. The reduction in the interference between light components makes it possible to reduce speckles with a simple structure using the diffusion unit. In this way, it is possible to obtain a protector capable of reducing speckles with a simple structure. According to the above-mentioned structure, it is possible to reduce speckles using the diffusion unit that is provided on an optical path from a light source to a projection optical system. Therefore, even if a general screen not having a structure for reducing speckles is used, it is possible to display an image without speckles on the screen. When the diffusion unit diffuses light, it is possible to disperse the intensity of light emitted from the projection optical system. Since the diffusion unit disperses the intensity of light, it is possible to prevent defects due to the concentration of light.

In the protector according to the above-mentioned aspect, preferably, the diffusion unit randomly changes the phase of light incident according to the position of the diffusion unit. According to the above-mentioned structure, since the phase of light incident is randomly changed, it is possible to reduce the interference between light components. As a result, it is possible to reduce speckles.

In the projector according to the above-mentioned aspect, preferably, the diffusion unit includes a member whose thickness in an optical axis direction and/or refractive index is randomly distributed in a two-dimensional direction substantially perpendicular to the optical axis direction. According to the above-mentioned structure, since the diffusion unit is provided with a member whose thickness in the optical axis direction and/or refractive index is randomly distributed in the direction perpendicular to the optical axis direction, it is possible to chance the optical distance of light traveling through the diffusion unit according to the incident position of light. In this way, it is possible to randomly change the phase of light from the emission surface of the diffusion unit at positions where light is incident on the diffusion unit.

In the projector according to the above-mentioned aspect, preferably, the diffusion unit diffuses light by means of diffraction. The diffusion of light by means of diffraction makes it possible to appropriately control the diffusion angle of light As a result, it is possible to reduce speckles and thus reduce the loss of light.

In the projector according to the above-mentioned aspect, preferably, the diffusion unit rotates on an optical axis. According to the above-mentioned structure, it is possible to sequentially change a speckle pattern of light emitted from the diffusion unit by rotating the diffusion unit. A plurality of speckle patterns are superimposed such that the viewer cannot see a specific speckle pattern, which makes it possible to effectively reduce the speckles. For example, when a diffusion unit having sufficiently minute concave and convex portions formed in one surface thereof is used, it is possible to sufficiently change the speckle pattern by slightly changing the diffusion unit, as compared to the structure in which a fly eye lens is rotated to divide light into a plurality of light components. The displacement of the diffusion unit per unit time can be reduced, which makes it possible to simplify a structure for rotating the diffusion unit. In this way, it is possible to reduce speckles with a simple structure.

In the projector according to the above-mentioned aspect, preferably, the diffusion unit is vibrated. According to the above-mentioned structure, the vibration of the diffusion unit makes it possible to sequentially change the speckle pattern of light emitted from the diffusion unit. A plurality of speckle patterns are superimposed such that the viewer cannot see a specific speckle pattern, which makes it possible to effectively reduce the speckles. When the diffusion unit is used, in is possible to sufficiently vary the speckle pattern of light by slightly changing the position of the diffusion unit. Therefore, it is possible to simplify a structure for applying vibration to the diffusion unit. As a result, it is possible to reduce speckles with a simple structure.

In the projector according to the above-mentioned aspect, preferably, the diffusion unit includes: a dispersion layer that has a fluid and charged particles dispersed in the fluid; and electrodes that apply a voltage to the dispersion layer. According to the above-mentioned structure, since the dispersion layer and the electrodes are provided in the diffusion unit, the charged particles can be randomly moved by an electric field generated between the electrodes and the repulsion between the charged particles. The random displacement of the charged particles makes it possible to change the speckle pattern of light emitted from the diffusion unit. A plurality of speckle patterns are superimposed such that the viewer cannot see a specific speckle pattern, which makes it possible to effectively reduce the speckles. As a result, it is possible to reduce speckles with a simple structure.

In the projector according to the above-mentioned aspect, preferably, the diffusion unit includes a polymer dispersed liquid crystal member composed of a polymer material and liquid crystal molecules dispersed in the polymer material, and the state of the polymer dispersed liquid crystal member is repeatedly changed between a first state in which light emitted from the polymer dispersed liquid crystal member is diffused and a second state in which the diffusion of light is smaller than that in the first state by varying the alignment of the liquid crystal molecules. In the polymer dispersed liquid crystal (PDLC), the alignment of the liquid crystal molecules dispersed in the polymer varies according to a voltage pattern applied. The variation in the alignment of the liquid crystal molecules makes possible to sequentially change the dispersion characteristics of light emitted from the polymer dispersed liquid crystal member. The change in the dispersion characteristics of light makes it possible to change the speckle pattern of light emitted from the diffusion unit. A plurality of speckle patterns are superimposed such that the viewer cannot see a specific speckle pattern, which makes it possible to effectively reduce the speckles. As a result, it is possible to reduce speckles with a simple structure.

In the projector according to the above-mentioned aspect, preferably, the size of the image formed on the diffusion unit is smaller than the size of an image projected by the projection optical system. According to the above-mentioned structure, it is possible to use a small diffusion unit.

In the projector according to the above-mentioned aspect, preferably, the image forming unit includes a spatial light modulator that modulates the light emitted from the solid-state light source in response to an image signal, and the projector further includes an imaging optical system that focuses the light components modulated by the spatial light modulator on the diffusion unit. According to the above-mentioned structure, a combination of the spatial light modulator and the imaging optical system makes it possible to focus light component of an image formed by the spatial light modulator on the diffusion unit.

In the projector according to the above-mentioned aspect, preferably, the imaging optical system includes a telecentric optical system. The use of the telecentric optical system enables light emitted from the spatial light modulator at any position to be uniformly incident on the diffusion unit. In addition, when the main light beams substantially parallel to an optical axis are incident on the diffusion unit, light beams emitted from the diffusion unit are diffused at substantially uniformly from the optical axis. Since the light beams are diffused at substantially regular angles with respect to the optical axis it is possible to make light emitted from the diffusion unit incident on the projection optical system with a high degree of efficiency and thus reduce the loss of light. In this way, it is possible to display an image with high and uniform brightness.

In the projector according to the above-mentioned aspect, preferably, the imaging optical system forms an image having a size that is 0.2 to 10 times the size of the spatial light modulator on the diffusion unit. In this way, it is possible to use a small diffusion unit.

In the projector according to the above-mentioned aspect, preferably, an F number of the imaging optical system is larger than an F number of the projection optical system. In general, the spatial light modulator emits light within a relatively narrow angle range. Since the diffusion unit can increase the diffusion angle of light, the imaging optical system can receive light within a narrow angle range from the spatial light modulator and emit light in a narrow diffusion angle range to the diffusion unit. Since the diffusion unit increases the diffusion angle of light, the projection optical system can receive light within a wide diffusion angle range from the diffusion unit and emit light within a wide diffusion angle range at a small back focus. In this way, the projector can use the imaging optical system having a small number of lenses and the projection optical system that is easy to design. Therefore, it is possible to reduce the cost of manufacturing the imaging optical system and the projection optical system. In addition, is possible to sufficiently diffuse light: emitted from the projection optical system and thus prevent light from being concentrated.

In the projector according to the above-mentioned aspect, preferably, the spatial light modulator is a liquid-crystal spatial light modulator. According to the above-mentioned structure, it is possible to form an image in response to an image signal.

In the projector according to the above-mentioned aspect, preferably, the spatial light modulator includes a minute mirror array device. According to the above-mentioned structure, it is possible to form an image in response to an image signal.

In the projector according to the above-mentioned aspect, preferably, the image forming unit includes a light scanning device that scans the diffusion unit with the light emitted from the solid-state light source to form an image. The use of the light scanning device makes it possible to form an intermediate image on the diffusion unit.

In the protector according to the above-mentioned aspect, preferably, the light scanning device includes a light beam shaping unit that shapes the light emitted from the solid-state light source into a linear light beam having a longitudinal direction as a first direction; a spatial light modulator that modulates the linear light beam in response to an image signal; and a scanning unit that scans the diffusion unit in a second direction substantially perpendicular to the first direction with the linear light beam emitted from the spatial light modulator. According to the above-mentioned structure, it is possible to form an image in response to an image signal.

In the projector according to the above-mentioned aspect, preferably, the light scanning device includes a scanning unit that scans the diffusion unit in a first direction and a second direction substantially perpendicular to the first direction with the light emitted from the solid-state light source. According to the above-mentioned structure, it is possible to form an image in response to an image signal.

In the projector according to according to the above-mentioned aspect, preferably the solid-state light source is a laser light source. Since the laser beam has a single wavelength, the laser beam is characterized in that it has high color purity and high coherence and is easily shaped. The laser light source has advantages in that it has a small size and can be instantly turned on. Therefore, the projector having the laser light source has a small size and can display a high-quality image. According to the above-mentioned aspect of the invention, the use of the laser beam, which is coherent light, is used, makes it possible to reduce speckles.

### BRIEF DESCRIPTION OF THE DRAWINGS

The invention will be described with reference to the accompanying drawings, wherein like numbers refer like elements.

FIG. 1 is a diagram schematically illustrating the structure of a projector according to a first embodiment of the invention.

FIG. 2 is a diagram illustrating a structure for supplying and modulating an R light component.

FIG. 3 is a diagram illustrating a structure from an imaging optical system to a projection optical system.

FIG. 4 is a cross-sectional view of a main portion of a diffusion unit.

FIG. 5 is a diagram illustrating the size of a liquid-crystal spatial light modulator, the size of an intermediate image, and the size of an image.

FIG. 6 is a diagram illustrating a diffusion unit having refractive indexes randomly distributed.

FIG. 7 is a diagram illustrating a diffusion unit that diffuses light by diffraction.

FIG. 8 is a diagram illustrating a diffusion unit that is rotatably provided.

FIG. 9 is a diagram illustrating a diffusion unit integrated with a vibration applying unit.

FIG. 10 is a diagram illustrating a diffusion unit moving charged particles using an electric field.

FIG. 11 is a diagram illustrating a diffusion unit having a polymer dispersed liquid crystal member.

FIG. 12 is a diagram illustrating a diffusion unit in a first state.

FIG. 13 is a diagram illustrating a diffusion unit in a second state.

FIG. 14 is a diagram schematically illustrating the structure of a projector according to a second embodiment of the invention.

FIG. 15 is a diagram schematically illustrating the structure of a projector according to a third embodiment of the invention.

FIG. 16 is a diagram schematically illustrating the structure of a projector according to a fourth embodiment of the invention.

### DESCRIPTION OF EXEMPLARY EMBODIMENTS

Hereinafter, exemplary embodiments of the invention will be described with reference to the accompanying drawings.

### First Embodiment

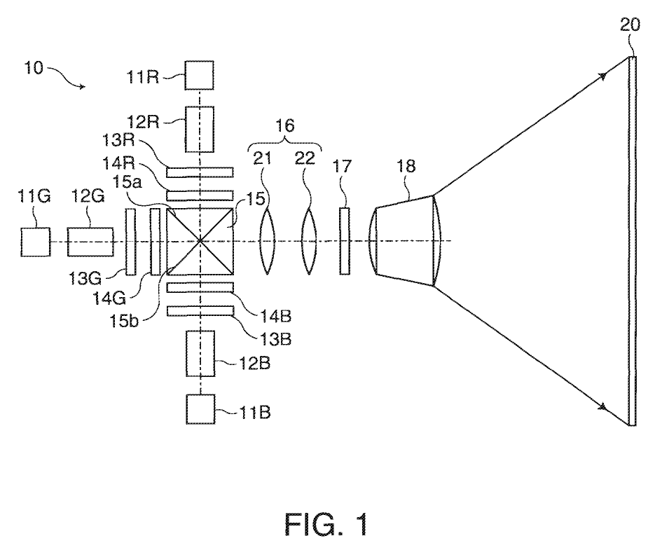

FIG. 1 is a diagram schematically illustrating the structure of a projector 10 according to a first embodiment of the invention. The projector 10 is a so-call front projector which displays an image to a viewer by using light that has been emitted to a screen 20 and then reflected from the screen 20. The projector 10 displays an image using a red laser beam (hereinafter, referred to as an ‘R light component’), a green laser beam (hereinafter, referred to as a G light component), and a blue laser beam (hereinafter, referred to as a ‘B light component’).

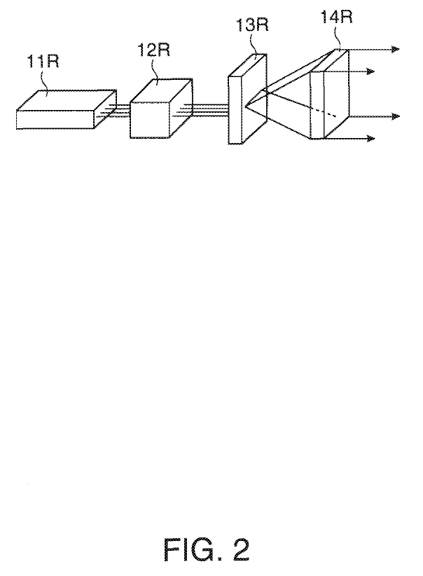

FIG. 2 is a diagram illustrating a structure for supplying and modulating the R light component in the projector 10. A light source unit 11R supplies four laser beams having the same or similar wavelength range. The use of a plurality of laser beams makes it possible to supply a large amount of light. The light source unit 11R includes four semiconductor lasers, which are solid-state light sources. Alternatively, the light source unit 11R may be a surface-emitting semiconductor laser having four light-emitting portions arranged in parallel to each other. A wavelength converting element 12R converts the wavelengths of a plurality of laser beams emitted from the light source unit 11R and reflects the R light component. For example, a second-harmonic generation (SHG) element may be used as the wavelength converting element 12R. The SHG element converts an incident laser beam into a laser beam having a wavelength that is half the wavelength of the incident laser beam and reflects the converted laser beam.

For example, a non-linear optical crystal may be used as the SHG element. The wavelength converting element 12R makes it possible to use a general-purpose laser light source that is easy to acquire. For example, a third harmonic generation (THG) element or an optical parametric oscillation element other than the SHG element may be used as the wavelength converting element 12R. In addition, the wavelength converting element 12R may be omitted, or a diode pumped solid state (DPSS) laser may be used.

A diffraction optical element 13R diffracts four R light components emitted from the wavelength converting element 12R. The diffraction optical element 13R makes the intensity distribution of light beams on a rectangular illumination region of a liquid-crystal spatial light modulator 14R uniform. For example, a computer generated hologram (CGH) may be used as the diffraction optical element 13R. The liquid-crystal spatial light modulator 14R is a transmissive liquid crystal display device for modulating the R light component in response to an image signal, and serves as an image forming device for forming an image using the R light component. Referring to FIG. 1 again, the R light component modulated by the liquid-crystal spatial light modulator 14R is incident on a cross dichroic prism 15, which is a color combining optical system.

A structure for supplying and modulating the G light component is the same as the structure for supplying and modulating the R light component. A wavelength converting element 12G converts the wavelengths of four laser beams emitted from a light source unit 11G. A diffraction optical element 13G diffracts the four G light components emitted from the wavelength converting element 12G. A liquid-crystal spatial light modulator 14G is a transmissive liquid crystal display device for modulating the G light component in response to an image signal, and serves as an image forming device for forming an image using the G light component. The G light component modulated by the liquid-crystal spatial light modulator 14G is incident on the cross dichroic prism 15, which is a color combining optical system.

A structure for supplying and modulating the B light component is the same as the structure for supplying and modulating the R light component. A wavelength converting element 12B converts the wavelengths of four laser beams emitted from a light source unit 11B. A diffraction optical element 13B diffracts the four B light components emitted from the wavelength converting element 12B. A liquid-crystal spatial light modulator 14B is a transmissive liquid crystal display device for modulating the B light component in response to an image signal, and serves as an image forming device for forming an image using the B light component. The B light component modulated by the liquid-crystal spatial light modulator 14B is incident on the cross dichroic prism 15, which is a color combining optical system. In this embodiment, four laser beams are emitted from each of the light source units 11R, 11G, and 11B, but the number of laser beams emitted from each of the light source units 11R, 11G, and 11B is not limited to four.

The cross dichroic prism 15 includes two dichroic films 15a and 15b arranged so as to be substantially orthogonal to each other. The first dichroic film 15a reflects the R light component, but transmits the G and B light components. The second dichroic film 15b reflects the B light component, but transmits the R and G light components. The cross dichroic prism 15 combines the R, G, and B light components incident thereon in different directions. An imaging optical system 16 and a diffusion unit 17 are provided on an optical path between the cross dichroic prism 15 and a projection optical system 18.

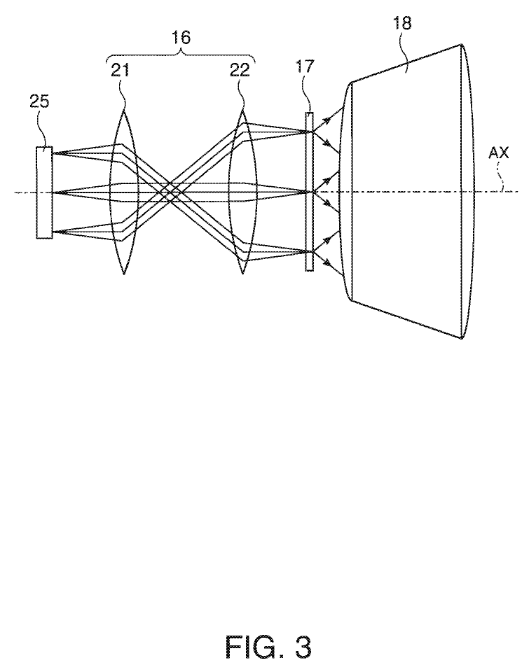

FIG. 3 is a diagram illustrating a structure from the imaging optical system 16 to the projection optical system 18. The imaging optical system 16 includes a first lens 21 and a second lens 22. The imaging optical system 16 condenses light components forming an image 25 of the liquid-crystal spatial light modulator on the diffusion unit 17. The first lens 21 and the second lens 22 of the imaging optical system 16 form a telecentric optical system. Light whose main light beams are substantially parallel to an optical axis AX is incident on the first lens 21 of the imaging optical system 16 from the image 25 formed by the liquid-crystal spatial light modulator. Light whose main light beams are substantially parallel to the optical axis AX is emitted from the second lens 22 of the imaging optical system 16 to the diffusion unit 17.

The diffusion unit 17 is provided at focal positions of light components of the image 25 formed by the liquid-crystal spatial light modulator. The diffusion unit 17 diffuses light emitted from the imaging optical system 16. The projection optical system 18 projects light emitted from the diffusion unit 17 onto the screen 20 (see FIG. 1). The structure for forming an intermediate image on the diffusion unit 17 makes it possible to form an image on, the screen 20 using light diffused by the diffusion unit 17.

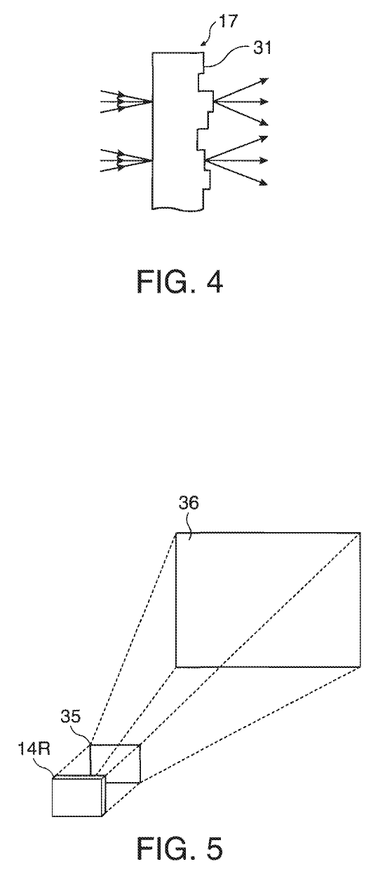

FIG. 4 is a cross-sectional view of the main part of the diffusion unit 17. The diffusion unit 17 has a flat incident surface and an uneven emission surface 31. Concave and convex portions of the uneven emission surface 31 are randomly formed in a two-dimensional direction that is substantially perpendicular to the optical axis. The thickness of the diffusion unit 17 in the optical axis direction is randomly distributed in the two-dimensional direction that is substantially perpendicular to the optical axis. The diffusion unit 17 may be formed of a transparent material.

Light incident on the diffusion unit 17 is emitted from the uneven surface 31 to be diffused. The thickness of the diffusion unit 17 in the optical axis direction that is randomly distributed in the two-dimensional direction substantially perpendicular to the optical axis makes it possible to vary the optical distance of light passing through the diffusion unit 17 when light is incident on the diffusion unit 17 at different positions. The variation in the optical distance of light makes it possible to randomly change the phase of light emitted from the emission surface of the diffusion unit 17 at positions where light is incident on the diffusion unit 17.

It is possible to reduce the interference between light components by increasing the diffusion angle of light using the diffusion unit 17. The reduction in the interference between light components and a simple structure using the diffusion unit 17 makes it possible to reduce speckles. In this way, it is possible to reduce speckles with a simple structure. In this embodiment, since the diffusion unit 17 provided on the optical path from the light source unit to the projection optical system 18 can be used to reduce speckles, it is possible to display an image with reduced speckles, even in the case that the structure in which a general screen 20 not having a function of reducing the speckles is used.

When light is diffused by the diffusion unit 17, the intensity of light emitted from the projection optical system 18 can be diffused. The diffusion of the intensity of light by the diffusion unit 17 makes it possible to prevent laser beams from being concentrated on one point. The diffusion unit 17 may be formed by dispersing a diffusion material for diffusing light in a transparent material. The diffusion unit 17 having the diffusion material dispersed in the transparent material can diffuse light well.

The use of the imaging optical system 16 (see FIG. 3) having the telecentric optical system enables light emitted from the liquid-crystal spatial light modulator at any position to be uniformly incident on the diffusion unit 17. In addition, since light whose main light beams are substantially parallel to the optical axis AX is incident on the diffusion unit 17, light emitted from the diffusion unit 17 is substantially uniformly diffused along the optical axis AX. The diffusion of light along the optical axis AX enables light from the diffusion unit 17 to be incident on the projection optical system 18 with a high degree of efficiency, which makes it possible to reduce the loss of light. In this way, it is possible to display an image with high brightness and uniform brightness.

FIG. 5 is a diagram illustrating the size of an image formed by the liquid-crystal spatial light modulator 14R, the size of an intermediate image 35 formed by the diffusion unit 17, and the size of an image 36 projected onto the screen 20. The liquid-crystal spatial light modulators 14R, 14G, and 14B have substantially the same size. The imaging optical system 16 forms the intermediate image 35 having the same size as the liquid-crystal spatial light modulators 14R. The intermediate image 35 is smaller than the image 36 projected by the projection optical system 18. The magnification of the imaging optical system 16 is smaller than that of the projection optical system 18. In this way, it is possible to use the diffusion unit 17 having a size substantially equal to the size of the liquid-crystal spatial light modulator 14R. In this embodiment, the imaging optical system 16 forms the intermediate image 35 having a size substantially equal to the size of the liquid-crystal spatial light modulator, but the invention is not limited thereto. For example, the imaging optical system 16 may form on the diffusion unit 17 an intermediate image having a size that is 0.2 to 10 times larger than the size of the liquid-crystal spatial light modulator. The size of the diffusion unit 17 may be 0.2 to 10 times the size of the liquid-crystal spatial light modulator.

Since the angle range of available light beams is limited, the liquid-crystal spatial light modulator emits light within a relatively narrow angle range. The light within a narrow angle range emitted from the liquid-crystal spatial light modulator is diffused into light within a large angle range by the diffusion unit 17 and is then incident on the projection optical system 18. In this way, the F number of the imaging optical system 16 can be larger than that of the projection optical system 18. The imaging optical system 16 can receive light within a narrow angle range from the liquid-crystal spatial light modulator and emit light within a narrow diffusion angle range to the diffusion unit 17. The projection optical system 18 can receive light within a wide diffusion angle range from the diffusion unit 17 and emit light within a wide diffusion angle range at a small back focus.

In this way, the projector 10 can use the imaging optical system 16 having a small number of lenses and the projection optical system 18 that is easy to design. Therefore it is possible to reduce the cost of manufacturing the imaging optical system 16 and the projection optical system 18. In addition, it is possible to sufficiently disperse the intensity of light emitted from the projection optical system 18 and thus prevent laser beams from being concentrated.

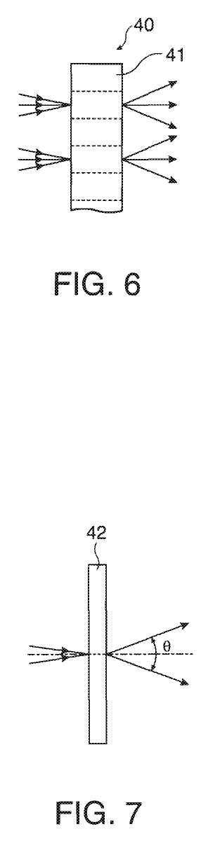

FIGS. 6 to 13 are diagrams illustrating modifications of the diffusion unit. A diffusion unit 40 shown in FIG. 6 has a flat incident surface and a flat emission surface. The diffusion unit 40 is composed of a member in which regions 41 having different refractive indexes are randomly distributed in a two-dimensional direction substantially perpendicular to an optical axis. Light incident on the diffusion unit 40 passes through the regions 41 having different refractive indexes to be diffused. The regions 41 having different refractive indexes that are randomly distributed in the two dimensional direction substantially perpendicular to the optical axis make it possible to vary the optical distance of light passing through the diffusion unit 40 when light is incident on the diffusion unit 40 at different positions. The variation in the optical distance of light makes it possible to randomly change the phase of light emitted from the emission surface of the diffusion unit 40. Both the thickness of the diffusion unit in the optical axis direction and the refractive index of the diffusion unit may be randomly distributed.

A diffusion unit 42 shown in FIG. 7 is a diffraction optical element that diffuses light by diffraction. For example, a computer generated hologram (CGH) may be used as the diffraction optical element. The diffusion unit 42 diffuses light incident thereon at an angle of several degrees with respect to the optical axis, which is a reference, to be emitted therefrom within an angle range of θ=±20°, thereby reducing light diffused at an angle equal to or larger than 25°. The diffusion of light by means of diffraction makes it possible to appropriately control the diffusion angel of light. In addition, it is possible to prevent light from deviating from an optical path to the projection optical system 18 and thus reduce the loss of light by reducing light diffused at a diffusion angle larger than a predetermined angle. This structure makes it possible to reduce speckles and reduce the loss of light.

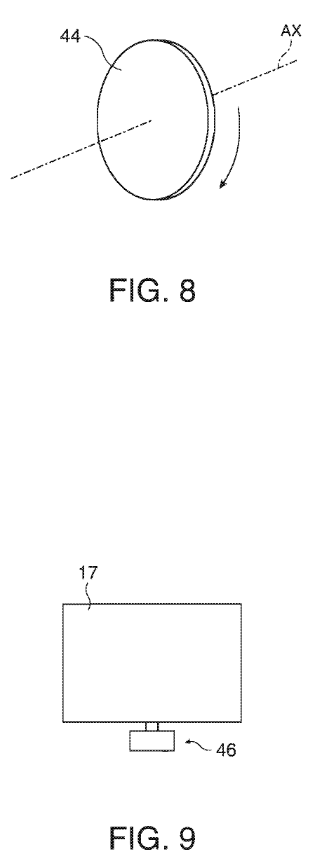

A diffusion unit 44 shown in FIG. 8 is provided such that it can rotate on the optical axis AX. Similar to the diffusion unit 17 shown in FIG. 4, the thickness of the diffusion unit 44 in the direction of the optical axis Ax is randomly distributed in the two-dimensional direction that is substantially perpendicular to the optical axis. The diffusion unit 44 has a circular shape having the center on the optical axis AX. The diffusion unit 44 is formed in a size including the size of an intermediate image formed by the imaging optical system 16. The diffusion unit 44 can be rotated by, for example, a rotary wheel (not shown) and an electric motor (not shown) for rotating the rotary wheel.

It is possible to sequentially change a speckle pattern of light emitted from the diffusion unit 44 by rotating the diffusion unit 44 on the optical axis AX. It is possible to effectively reduce speckles by superimposing a plurality of speckle patterns such that a viewer cannot perceive a specific speckle pattern. The diffusion unit 44 has sufficiently minute concave and convex portions (see FIG. 4) to reduce the interference between light components formed in one surface thereof. When the diffusion unit 44 having minute concave and convex portions (see FIG. 4) formed in one surface thereof is used, it is possible to sufficiently change the speckle pattern by slightly changing the diffusion unit 44, as compared to the structure in which a fly eye lens is rotated to divide light into a plurality of light components. The displacement of the diffusion unit 44 per unit time can be reduced, which makes it possible to simplify a structure for rotating the diffusion unit 44. In this way, it is possible to further reduce speckles with a simple structure. In this embodiment, the diffusion unit 44 whose thickness is randomly distributed in the direction of the optical axis AX rotates, but the invention is not limited thereto. For example, a diffusion unit whose refractive index is randomly distributed in the direction of the optical axis AX may rotate.

A diffusion unit 17 shown in FIG. 9 is provided so as to be integrated with a vibration applying unit 46. For example, an electric motor for repeatedly changing the shape of the diffusion unit 17 into a circular or elliptical shape on the plane perpendicular to the optical axis can be used as the vibration applying unit 46. Alternatively, a vibration motor may be used as the vibration applying unit 46. For example, the vibration motor can generate vibration by rotating an eccentric rotator. It is possible to sequentially change the speckle pattern of light emitted from the diffusion unit 17 by using the vibration applying unit 46 to vibrate the diffusion unit 17. It is possible to effectively reduce speckles by superimposing a plurality of speckle patterns such that a viewer cannot perceive a specific speckle pattern. In this embodiment, the diffusion unit 17 whose thickness is randomly distributed in the direction of the optical axis AX is vibrated, but the invention is not limited thereto. For example, the diffusion unit 40 (see FIG. 6) whose refractive index is randomly distributed in the direction of the optical axis AX may be vibrated.

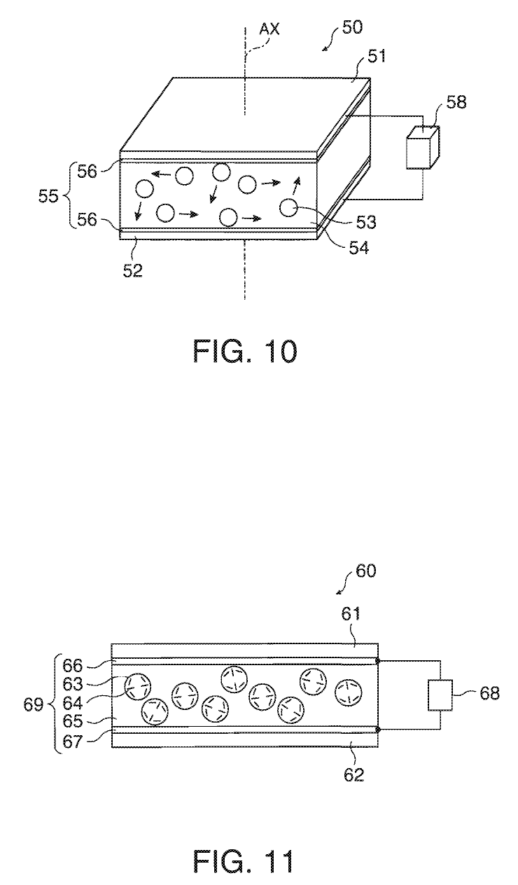

A diffusion unit 50 shown in FIG. 10 is an electrophoresis device that moves charged particles 53 using an electric field. The charged particles 53 are dispersed in a fluid 54 of a dispersion layer 55. The charged particles 53 have a single polarity, for example, a positive polarity. Te charged particles 53 diffuse laser beams. The fluid 54 having the charged particles 53 dispersed therein is provided between two transparent substrates 56, thereby forming the dispersion layer 55. Each of the charged particles 53 has a substantially spherical shape having a diameter of 1 μm to 10 μm. For example, particles obtained by coating resin particles having a diameter of 1 μm to 10 μm with, for example, a titanium oxide may be used as the charged particles 53.

Any of the following materials may be used as the fluid 54: a material that has low solubility with respect to the charged particles 53 and is capable of stably dispersing the charged particles 53; and an insulating material that does not include ions and does not generate ions when a voltage is applied. In addition, in order to effectively move the charged particles 53, preferably, a material that has a specific gravity substantially equal to those of the charged particles 53 and is capable of preventing the sinking and floating of the charged particles 53, or a material having low viscosity may be used as the fluid 54. Any of the following insulating liquids may be used as the fluid 54 having the charged particles dispersed therein: hexane, decane, hexadecane, kerosene, toluene, xylene, olive oil, tricresyl phosphate, isopropanol, trichlorotrifluoroethane, and dibromotetrafluoroethane, tetrachloroethane. The fluid 54 may be composed of a mixture of a plurality of materials to achieve specific gravity matching with the charged particles 53.

Further, the dispersion layer 55 is interposed between a first electrode 51 and a second electrode 52. The first electrode 51 is formed on one surface of the dispersion layer 55, for example, an incident surface of the dispersion layer 55. The second electrode 52 is formed on the other surface of the dispersion layer 55 opposite to the surface on which the first electrode 51 is formed of, for example, an emission surface of the dispersion layer 55. A driving unit 58 is connected to the first electrode 51 and the second electrode 52. A voltage is applied to the dispersion layer 55 by the first electrode 51 and the second electrode 52. The first electrode 51 and the second electrode 52 may be formed of, for example, a metal oxide, such as ITO or IZO.

For example, it is considered that a voltage is applied to the dispersion layer 55 using the first electrode 51 as an anode and the second electrode 52 as a cathode. In this case, repulsion occurs between the first electrode 51 and the charged particles 53 having a positive polarity, and attraction occurs between the second electrode 52 and the charged particles 53 having a positive polarity. Then, a voltage is applied to the dispersion layer 55 using the first electrode 51 as a cathode and the second electrode 52 as an anode. In this case, repulsion occurs between the second electrode 52 and the charged particles 53 having a positive polarity, and attraction occurs between the first electrode 51 and the charged particles 53 having a positive polarity. In this way, the driving unit 53 alternately changes the polarities of the first electrode 51 and the second electrode 52. The charged particles 53 having a positive polarity repel each other. The charged particles 53 move randomly in the dispersion layer 55 by the repulsion therebetween in addition to the voltage applied thereto by the first electrode 51 and the second electrode 52. It is possible to randomly move the charged particles 53 in the fluid 54 by dispersing the charged particles 53 in the fluid 54.

It is possible to change the speckle pattern of light emitted from the dispersion layer 50 by randomly moving the charged particles 53. Further, it is possible to effectively reduce speckles by superimposing a plurality of speckle patterns such that a viewer cannot perceive a specific speckle pattern. In this way, it is possible to reduce the speckles. In the dispersion unit 50, a plurality of first electrodes may be provided on the entire incident surface of the dispersion layer 50, and a plurality of second electrodes may be provided on the entire emission surface of the dispersion layer 55. In the case, it is possible to randomly move the charged particles 53 by changing the polarities of plural pairs of first and second electrodes at different timings.

A diffusion unit 60 shown in FIG. 11 includes a polymer dispersed liquid crystal member 69. The polymer dispersed liquid crystal member 69 is formed of a polymer material 65 and liquid crystal molecules 64 dispersed therein. In the polymer dispersed liquid crystal member 69, the particles 63 are dispersed in the polymer material 65 in the form of microcapsules, that is, the particles 63 containing the liquid crystal molecules 64 therein are dispersed in the polymer material 65. The polymer dispersed liquid crystal member 69 may be formed by separating the polymer material 65 from the liquid crystal molecules 64 by means of phase separation caused by polymerization.

The diffusion unit 60 changes the alignment of the liquid crystal molecules according to a voltage pattern applied between a first electrode 66 and a second electrode 67. For example, the liquid crystal molecules 64 are generally aligned in the direction of an electric filed generated by a voltage applied to the polymer dispersed liquid crystal member 69. The first electrode 66 is formed on one surface of the polymer dispersed liquid crystal member 69, for example, an incident surface of the polymer dispersed liquid crystal member 69. The second electrode 67 is formed on the other surface of the polymer dispersed liquid crystal member 69 opposite to the surface on which the first electrode 66 is formed, for example, an emission surface of the polymer dispersed liquid crystal member 69. The first electrode 66, the polymer dispersed liquid crystal member 69, and the second electrode 67 are interposed between an incident-side transparent substrate 61 and an emission-side transparent substrate 62. A driving unit 68 is connected to the first electrode 66 and the second electrode 67. The first electrode 66 and the second electrode 67 may be formed of, for example, a metal oxide, such as ITO or IZO.

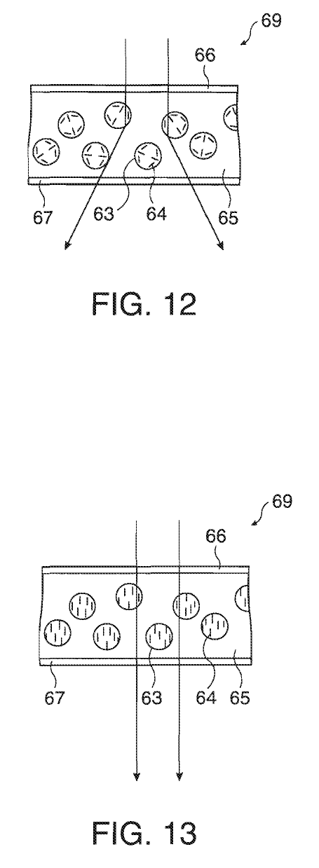

FIG. 12 is a diagram illustrating a first state in which the application of a voltage to the polymer dispersed liquid crystal member 69 stops. When the application of a voltage to the polymer dispersed liquid crystal member 69 stops, the liquid crystal molecules 64 are randomly arranged. When the liquid crystal molecules 64 are randomly arranged, the polymer material 65 and the particles 63 of the polymer dispersed liquid crystal member 69 have different refractive indexes. When the polymer material 65 and the particles 63 have different refractive indexes, light incident on the polymer dispersed liquid crystal member 69 is refracted at the interfaces between the polymer material 65 and the particles 63 to be diffused. When the application of a voltage to the polymer dispersed liquid crystal member 69 stops, the diffusion unit 60 diffuses laser beams passing through the polymer dispersed liquid crystal member 69. When the application of a voltage to the polymer dispersed liquid crystal member 69 stops, the maximum diffusion of laser beams occurs.

FIG. 13 is a diagram illustrating a second state in which a voltage is applied to the polymer dispersed liquid crystal member 69 to align the liquid crystal molecules 64. When the liquid crystal molecules 64 are aligned, the difference between the refractive indexes of the polymer material 65 and the particles 63 of the polymer dispersed liquid crystal member 69 is smaller than that when the liquid crystal molecules 64 are randomly arranged. When the difference between the refractive indexes of the polymer material 65 and the particles 63 becomes small, light is diffused at a smaller angle in the polymer dispersed liquid crystal member 69, as compared to when the liquid crystal molecules 64 are randomly arranged. In this way, when a voltage is applied to the polymer dispersed liquid crystal member 69 so that the liquid crystal molecules 64 are aligned, laser beams are emitted at a small diffusion angle from the diffusion unit 60. When the maximum voltage is applied to the polymer dispersed liquid crystal member 69, the liquid crystal molecules 64 are aligned substantially uniformly, which results in the minimum diffusion of laser beams.

When the application and non-application of a voltage are repeated, the state of the polymer dispersed liquid crystal member 69 is repeatedly switched between the first state and the second state in the diffusion unit 60. A change in the alignment of the liquid crystal molecules 64 causes the diffusion characteristics of light emitted from the diffusion unit 60 to sequentially vary. The variation in the diffusion characteristics of light makes it possible to change the speckle pattern of light emitted from the diffusion unit 60. Further, it is possible to effectively reduce speckles by superimposing a plurality of speckle patterns such that a viewer cannot perceive a specific speckle pattern. In this way, it is possible to reduce the speckles.

The diffusion unit 60 may use a so-called polymer-network-type polymer dispersed liquid crystal member in which the liquid crystal molecules are dispersed in a polymer material formed in a mesh-like shape in a three-dimensional direction. In this case, is also possible to reduce speckles by sequentially changing the diffusion characteristics of light emitted from the diffusion unit 60, similar to the structure in which the microcapsule-type polymer dispersed liquid crystal member 69 is used.

### Second Embodiment

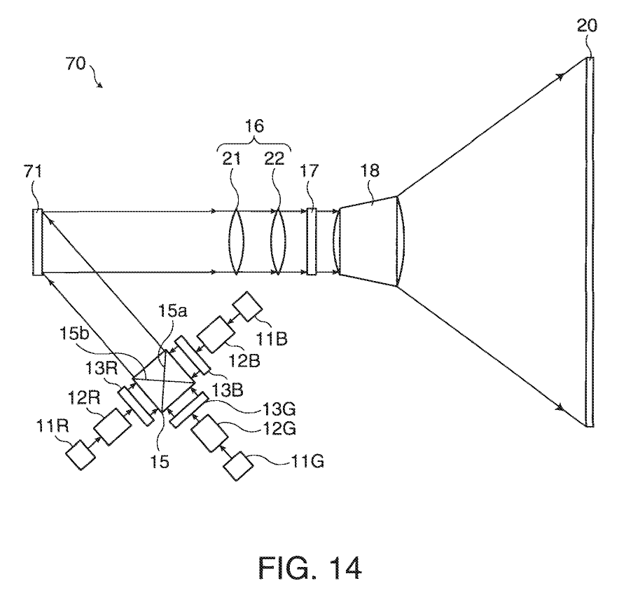

FIG. 14 is a diagram schematically illustrating the structure of a projector 70 according to a second embodiment of the invention. The projector 70 is characterized in that it has a minute mirror array device 71, which is a spatial light modulator. In the second embodiment, the same components as those in the first embodiment have the same reference numerals, and a description thereof will be omitted. An R light component emitted from a wavelength converting element 12R is incident on a cross dichroic prism 15 through a diffraction optical element 13R. A G light component emitted from a wavelength converting element 12G is incident on the cross dichroic prism 15 through a diffraction optical element 13G. A B light component emitted from a wavelength converting element 12B is incident on the cross dichroic prism 15 through a diffraction optical element 13B. The cross dichroic prism 15 makes the R, G, and B light components incident on the minute mirror array device 71.

The minute mirror array device 71 includes a plurality of movable mirror elements (not shown) formed on the surfaces on which the R, G, and B light components are incident. The movable mirror elements selectively move between a first reflecting position and a second reflecting position. When the light source units 11R, 11G, and 11B are sequentially turned on, R, G, and B light components are sequentially emitted to the minute mirror array device 71. The minute mirror array device 71 modulates the R, G, and B light components sequentially supplied. Light traveling to the imaging optical sensor 16 by the movable mirror element passes through the imaging optical system 16, the diffusion unit 17, and the projection optical system 18 to be projected onto the screen 20 as an image.

The diffusion unit 17 is provided at focal positions of light components of the image formed by the minute mirror array device 71, which is an image forming unit. The second embodiment can also reduce speckles with a simple structure, similar to the first embodiment. In the projector 70 according to this embodiment, a reflective liquid crystal display device (LCOS) may be used instead of the minute mirror array device 71.

### Third Embodiment

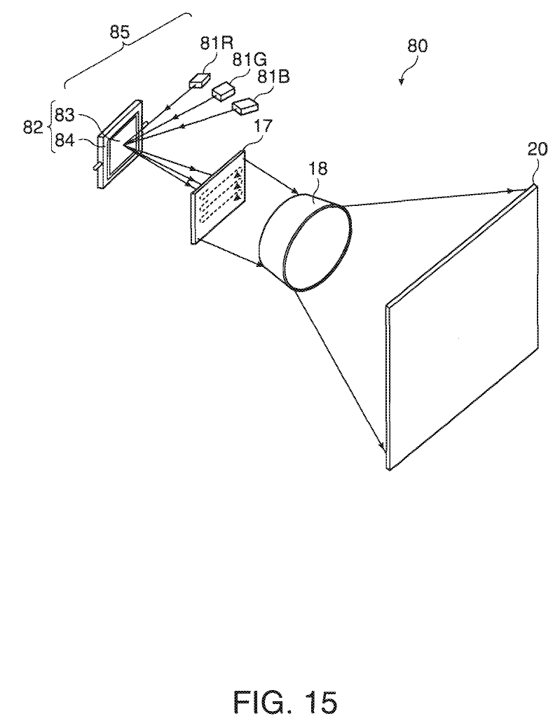

FIG. 15 is a diagram schematically illustrating the structure of a projector 80 according to a third embodiment of the invention. The projector 80 includes a light scanning device 85 that performs scanning with laser beams emitted from light source units 81R, 81G, and 81B. In the third embodiment, the same components as those in the first embodiment have the same reference numerals, and a description thereof will be omitted. The light scanning device 85 is an image forming unit that forms an image using the laser beams emitted from the light source units 81R, 81G, and 81B

The R light source unit 81R supplies an R light component modulated according to an image signal. The G light source unit 81G supplies a G light component modulated according to an image signal. The B light source unit 81B supplies a B light component modulated according to an image signal. The modulation according to an image signal may be amplitude modulation or pulse width modulation. Each of the light source units 81R, 81G, and 81B has a semiconductor laser, which is a solid-state light source. Each of the light source units SIR, 81G, and 81B may use a wavelength converting element or a DPSS laser.

A scanning unit 82 has a dual gimbal structure of a reflecting mirror 83 and a frame 84 provided around the reflecting mirror 83. The reflecting mirror 83 is rotated by a shaft between the reflecting mirror 83 and the frame 84 to reflect laser beams in a first direction. The frame 84 rotates together with the reflecting mirror 83 to reflect laser beams in a second direction substantially perpendicular to the first direction. In this way, the scanning unit 82 reflects laser beams emitted from the light source units 81R, 81G, and 81B in the first and second directions to scan the diffusion unit 17. The diffusion unit 17 is provided at focal positions of light components of the image formed by the light scanning device 85 serving as an image forming unit. The third embodiment can also reduce speckles with a simple structure, similar to the first embodiment.

### Fourth Embodiment

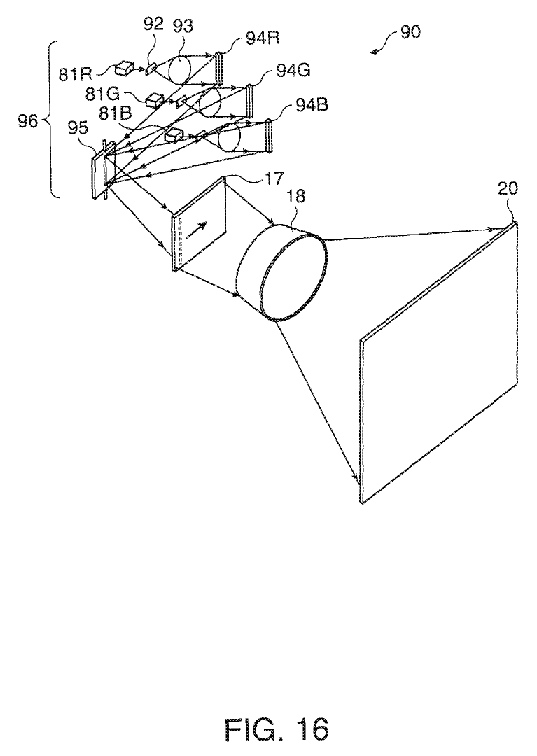

FIG. 16 is a diagram schematically illustrating the structure of a projector 90 according to a fourth embodiment of the invention. The projector 90 includes a light scanning device 96 that performs scanning with linear light beams. In the fourth embodiment, the same components as those in the third embodiment have the same reference numerals, and a description thereof will be omitted. The light scanning device 96 is an image forming unit that forms an image using laser beams emitted from the light source units 81R, 81G, and 81B.

A cylindrical lens 92, a collimator lens 93, and a spatial light modulator 94R are provided on an optical path between an R light source unit 81R and a scanning unit 95. The cylindrical lens 92 radiates laser beams emitted from the R light source unit 81R in the first direction. The collimator lens 93 collimates the light emitted from the cylindrical lens 92. The cylindrical lens 92 and the collimator lens 93 form a light beam shaping unit that shapes light emitted from the R light source unit 81R into a linear light beam having a longitudinal direction as the first direction.

The spatial light modulator 94R modulates linear light beams in response to an image signal. For example, a grating light valve (GLV) having light diffracting elements arranged in a line may be used as the spatial light modulator 94R. The structure of an optical path from a G light source unit 81G to a spatial light modulator 94G and the structure of an optical path from a B light source unit 81B to a spatial light modulator 94B are the same as the structure of the optical path from the R light source unit 81R to the spatial light modulator 94R.

The linear light beams emitted from the spatial light modulators 94R, 94G, and 94B are incident on the scanning unit 95. The scanning unit 95 rotates on a shaft to reflect the linear light beams in a second direction substantially perpendicular to the first direction, thereby scanning the diffusion unit 17 with the linear light beams. The diffusion unit 17 is provided at focal positions of light components of the image formed by the light scanning device 96 serving as an image forming unit. The fourth embodiment can also reduce speckles with a simple structure, similar to the first embodiment.

Each of the above-described projectors may use solid-state light sources other than the semiconductor laser, such as a solid-state laser and a light emitting diode (LED). Each of the projectors is not limited to a front projection type projector, but it may be a rear projector that displays an image to a viewer by using light that has been projected onto one surface of the screen and then emitted from the other surface of the screen.

As described above, the projector according to each of the above-described embodiments of the invention is suitable for a structure using a laser light source.

The entire disclosure of Japanese Patent Application No. 2006-102955, filed Apr. 4, 2006 is expressly incorporated by reference herein.

What is claimed is:

1. A projector comprising:
an image forming unit that forms an image using light emitted from a solid-state light source;
a diffusion unit which is provided at focal positions of light components of the image formed by the image forming unit and diffuses the light; and
a projection optical system that projects the light emitted from the diffusion unit.

2. The projector according to claim 1,
wherein the diffusion unit randomly changes the phase of light incident according to the position of the diffusion unit.

3. The projector according to claim 2,
wherein the diffusion unit includes a member whose thickness in an optical axis direction and/or refractive index is randomly distributed in a two-dimensional direction substantially perpendicular to the optical axis direction.

4. The projector according to claim 1,
wherein the diffusion unit diffuses light by means of diffraction.

5. The projector according to claim 1,
wherein the diffusion unit rotates on an optical axis.

6. The projector according to claim 1,
wherein the diffusion unit is vibrated.

7. The projector according to claim 1,
wherein the diffusion unit includes:
a dispersion layer that has a fluid and charged particles dispersed in the fluid; and
electrodes that apply a voltage to the dispersion layer.

8. The projector according to claim 1,
wherein the diffusion unit includes a polymer dispersed liquid crystal member composed of a polymer material and liquid crystal molecules dispersed in the polymer material, and
the state of the polymer dispersed liquid crystal member is repeatedly changed between a first state in which light emitted from the polymer dispersed liquid crystal member is diffused and a second state in which the diffusion of light is smaller than that in the first state by varying the alignment of the liquid crystal molecules.

9. The projector according to claim 1,
wherein the size of the image formed on the diffusion unit is smaller than the size of an image projected by the projection optical system.

10. The projector according to claim 1,
wherein the image forming unit includes a spatial light modulator that modulates the light emitted from the solid-state light source in response to an image signal, and
the projector further includes an imaging optical system that focuses the light components modulated by the spatial light modulator on the diffusion unit.

11. The projector according to claim 10,
wherein the imaging optical system includes a telecentric optical system.

12. The projector according to claim 10,
wherein tie imaging optical system forms an image having a size that is 0.2 to 10 times the size of the spatial light modulator on the diffusion unit.

13. The projector according to claim 10,
wherein an F number of the imaging optical system is larger than an F number of the projection optical system.

14. The projector according to claim 10,
wherein the spatial light modulator is a liquid-crystal spatial light modulator.

15. When projector according to claim 10,
wherein the spatial light modulator includes a minute mirror array device.

16. The projector according to claim 1,
wherein the image forming unit includes a light scanning device that scans the diffusion unit with the light emitted from the solid-state light source to form an image.

17. The projector according to claim 16,
wherein the light scanning device includes:
a light beam shaping unit that shapes the light emitted from the solid-state light source into a linear light beam having a longitudinal direction as a first direction;
a spatial light modulator that modulates the linear light beam in response to an image signal; and
a scanning unit that scans the diffusion unit In a second direction substantially perpendicular to the first direction with the linear light beam emitted from the spatial light modulator.

18. The projector according to claim 16,
wherein the light scanning device includes a scanning unit that scans the diffusion unit in a first direction and a second direction substantially perpendicular to the first direction with the light emitted from the solid-state light source.

19. The projector according to claim 1,
wherein the solid-state light source is a laser light source.
